(19) United States
(12) Patent Application Publication
(10) Pub. No.: US 2015/0280512 A1
(43) Pub. Date: Oct. 1, 2015

(54) ELECTRIC MOTOR HAVING SEAL MEMBER AND METHOD OF PRODUCING ELECTRIC MOTOR

(71) Applicant: FANUC CORPORATION, Yamanashi (JP)

(72) Inventor: Yasuyuki Nakazawa, Yamanashi (JP)

(21) Appl. No.: 14/669,526

(22) Filed: Mar. 26, 2015

(30) Foreign Application Priority Data
Mar. 31, 2014 (JP) 2014-072091

(51) Int. Cl. H02K 5/124; H02K 15/00

(52) U.S. Cl. CPC H02K 5/124; H02K 15/00

(57) ABSTRACT

A method of producing an electric motor is provided. The electric motor includes a housing portion attached to at least one of end portions in an axial direction, a rotor provided with a rotary shaft extending in the axial direction, and an annular seal member provided between the housing portion and the rotor. At least one of various types of seal members designed for different applications is selected as the seal member, and the selected seal member is customized in accordance with the shape of the housing portion and the rotary shaft.

### BACKGROUND OF THE INVENTION

1. Field of the Invention

The present invention relates to electric motors having a seal member and methods of producing electric motors.

2. Description of the Related Art

An electric motor used to drive a main shaft of a machine tool is provided, at its end in an axial direction, with a seal member to prevent foreign substances from entering the inside of the electric motor. A seal member using a biasing force of a coil spring or a labyrinth seal is generally used for this purpose.

JP2003-052145A discloses an oil seal structure in which in addition to an annular oil seal attached to a front cover, a dust lip or a labyrinth seal is provided on the outside of the annular oil seal in the axial direction of a motor, in order to improve a sealing effect.

A seal member having a coil spring is strongly pressed against a rotor by a biasing force of the coil spring. This could cause a portion of the seal member in contact with a rotary shaft to drastically wear out when an electric motor rotates at a high speed, possibly damaging the seal member. Further, the amount of heat generated by friction increases and as a result, the allowable rotation speed of the electric motor is decreased. On the other hand, a labyrinth seal, which provides a non-contact sealing action, is compatible with a motor operating at a high speed, but has disadvantages in that its sealing effect is lower than that of the seal member having a coil spring. Accordingly, seal members used for different applications have advantages and disadvantages, respectively.

There is a need for an electric motor which allows an appropriate seal member to be selected, depending on the intended use.

### SUMMARY OF THE INVENTION

According to a first aspect of the present invention, a method for producing an electric motor, the electric motor comprising a housing portion attached to at least one end portions in an axial direction, a rotor provided with a rotary shaft extending in the axial direction, and an annular seal member provided between the housing portion and the rotor, the method comprising selecting, as the seal member, at least one of various types of seal members designed for different applications, and customizing the selected seal member in accordance with the shape of the housing portion and the rotary shaft, is provided.

According to a second aspect of the present invention, the producing method according to the first aspect comprises selecting, as the seal member, at least one of a seal member having a coil spring, a seal member having no coil spring, and a labyrinth seal.

According to a third aspect of the present invention, the producing method according to the first aspect comprises selecting, as the seal member, a combination of a seal member having a coil spring and a labyrinth seal, or a combination of a seal member having no coil spring and a labyrinth seal.

According to a fourth aspect of the present invention, an electric motor comprising a housing portion attached to at least one of end portions in an axial direction, a rotor provided with a rotary shaft extending in the axial direction, and an annular seal member provided between the housing portion and the rotor, wherein the seal member is configured to wear out by friction generated when the rotary shaft rotates, so as to fit with the rotary shaft, is provided.

According to a fifth aspect of the present invention, in the electric motor according to the fourth aspect, the seal member is a seal member having no coil spring.

According to a sixth aspect of the present invention, a method for producing an electric motor, the electric motor comprising a housing portion attached to at least one of end portions in an axial direction, a rotor provided with a rotary shaft extending in the axial direction, and an annular seal member provided between the housing portion and the rotor, the method comprising placing the seal member between the housing portion and the rotor so that an entire inner circumferential surface of the seal member is brought into contact with the rotary shaft, and rotating the rotary shaft such that the seal member wears out so as to fit with the rotary shaft, is provided.

According to a seventh aspect of the present invention, the producing method according to the sixth aspect comprises determining an inner diameter of the seal member and an outer diameter of the rotary shaft such that the seal member has an interference between 0.1 mm and 0.3 mm, the seal member being a seal member having no coil spring.

These and other objects, features and advantages of the present invention will become more apparent in light of the detailed description of exemplary embodiments thereof as illustrated in the drawings.

### BRIEF DESCRIPTION OF THE DRAWINGS

FIG. 1 is a side view showing the entire configuration of an electric motor according to one embodiment of the present invention.

FIG. 2 is an enlarged view showing the vicinity of a front end of the electric motor shown in FIG. 1.

FIG. 3 is an enlarged view showing the vicinity of a front end of the electric motor shown in FIG. 1.

FIG. 4 is an enlarged view showing the vicinity of a front end of the electric motor shown in FIG. 1.

FIG. 5 is an enlarged view showing the vicinity of a rear end of the electric motor shown in FIG. 1.

### DETAILED DESCRIPTION OF THE INVENTION

Embodiments of the present invention will be described below with reference to the accompanying drawings. In order to help understand the present invention, constituent elements of the illustrated embodiments may be modified in size in relation to one another as necessary. The same or corresponding constituent elements are designated with the same referential numerals in the drawings.

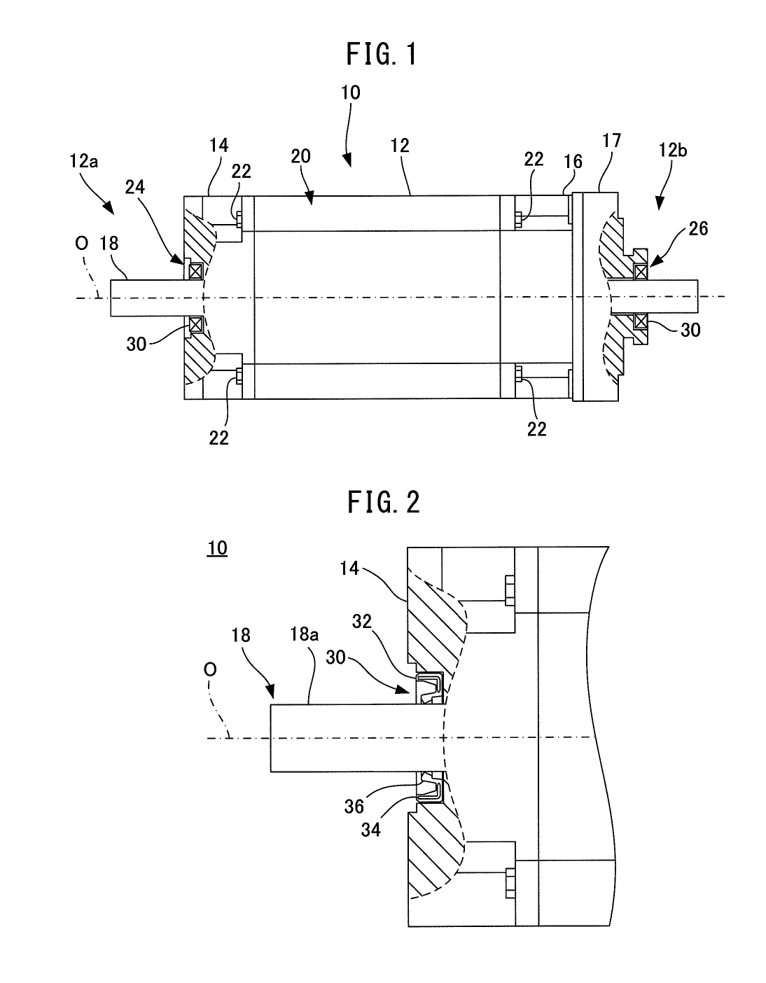

FIG. 1 is a side view showing the entire configuration of an electric motor 10 according to one embodiment of the present invention. The electric motor 10 is, for example, a three-phase induction motor used to drive a main shaft of a machine tool. The electric motor 10 includes a substantially cylindrical main body 12 extending in an axial direction, a front housing 14 attached to a front end 12a of the main body 12, a rear housing 16 attached to a rear end 12b of the main body 12, and a rear cover 17 attached to the rear housing 16.

The main body 12 of the electric motor 10 includes a rotor (not shown) having a rotary shaft 18 which extends in the axial direction of the electric motor 10 and rotates about a rotation axis 0, and a stator 20 provided on a radially outside of the rotor so as to surround the rotor. The electric motor 10 is configured so that the rotor rotates together with the rotary shaft 18 in response to a rotating magnetic field generated by three-phase alternating current supplied to coils (not shown) wound around the inner periphery of the stator 20. Although the outer shape of the main body 12 of the electric motor 10 is defined by the stator 20 in the illustrated embodiment, the electric motor 10 may also include a separate housing for accommodating the stator 20 therein.

The front housing 14 and the rear housing 16 are secured to the stator 20 by screws 22. Screw holes (not shown) are formed in the front housing 14. The electric motor 10 can be screwed in a predetermined location via the screw holes. The rear cover 17 is secured to the rear housing 16 by screws (not shown). In this way, the housing of the electric motor 10 may be configured from a plurality of components assembled together. A box or a frame which can accommodate the constituent elements of the electric motor 10 may be simply referred to as “housing” or “housing portion” in this specification.

FIG. 1 shows the sections of the vicinity of the front end 12aand the rear end 12b, respectively. The sections show that a recess 24 recessed from an end face facing the front end 12atoward the rear end 12bis formed around the rotary shaft 18, and that a recess 26 recessed toward the front end 12ais formed in the rear cover 17. As illustrated, seal members 30 are disposed in the recess 24 of the front housing 14 and the recess 26 of the rear cover 17, respectively.

The seal members 30 are annular members provided between the front housing 14 and the rotary shaft 18 and between the rear cover 17 and the rotary shaft 18 in order to close clearances formed therebetween. The seal members 30 can prevent foreign substances, such as cutting fluid, lubricant, dust, swarf, etc., from entering the inside of the electric motor 10.

Although the rotary shaft 18 of the electric motor 10 according to the illustrated embodiment protrudes from the main body 12 at the front end 12aand the rear end 12b, respectively, the present invention is not limited to such a configuration. The electric motor 10 may also be configured such that the rotary shaft 18 protrudes from the main body 12 at only one of the front end 12a and the rear end 12b.

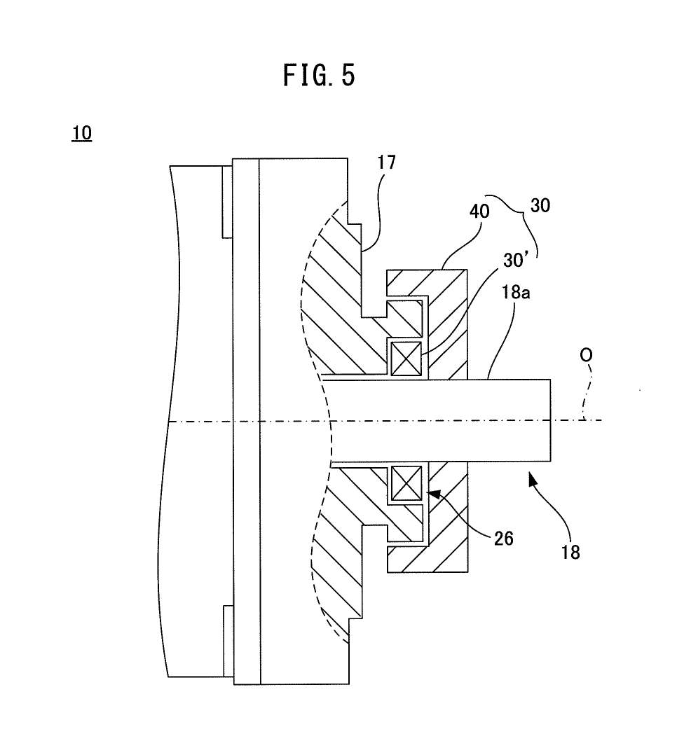

The configuration of the seal members 30 will be described with reference to FIGS. 2 to 5. FIGS. 2 to 4 are enlarged views showing the vicinity of the front end of the electric motor shown in FIG. 1. FIG. 5 is an enlarged view showing the vicinity of the rear end of the electric motor.

According to the present embodiment, the seal member 30 used in the electric motor 10 is selected from various types of seal members designed for different applications. Firstly, a designer selects the type of seal members in accordance with requested specifications and then customizes the selected seal members as necessary taking the shape of clearances to be sealed, the dimensions of the rotary shaft, etc. into consideration. Namely, the seal member selectively employed according to the present embodiment may be a customized product which is formed by modifying its outer diameter, inner diameter, material, etc. Seal members used in an electric motor are commonly selected from standard products having predetermined dimensions, which are listed in a catalog. By contrast, the method for producing the electric motor according to the present embodiment is different from the usual design method in that a standard product or a customized product is selectively adopted in accordance with the requested specifications. The seal member is selected from, for example, a seal member having no coil spring, a seal member having a coil spring, and a labyrinth seal.

FIG. 2 is an enlarged view showing the vicinity of the front end 12aof the electric motor 10 shown in FIG. 1. In the present embodiment, the seal member 30 has a main body 32 made of, for example, elastomer, a metal ring 34 having an L-shape in cross-section, which is embedded in the main body 32, and a lip portion 36 in contact with an outer peripheral surface 18a of the rotary shaft 18. The seal member 30 is a springless seal member which does not have a coil spring. The seal member 30 shown in FIG. 2 is, for example, a dust seal used to prevent solid matters, such as dust, swarf, etc., from entering the inside of the electric motor.

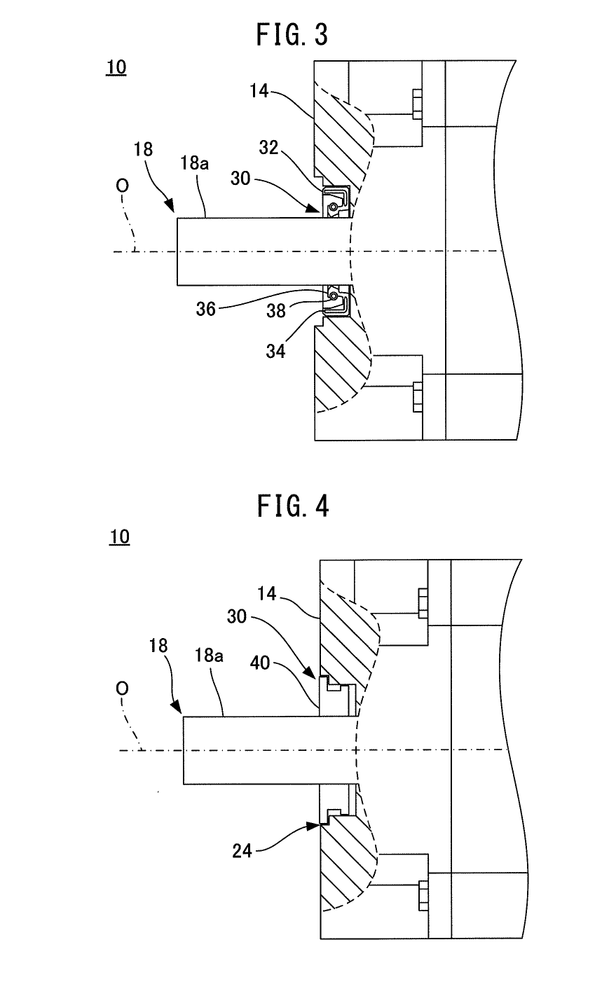

FIG. 3 shows an exemplary configuration of the present embodiment, in which the seal member 30 having a coil spring is used. The seal member 30 having a coil spring is, for example, an oil seal used to prevent fluid, such as lubricant, cutting fluid, etc., from entering the inside of the electric motor 10. The seal member 30 is provided with a coil spring 38 for applying a biasing force to press the lip portion 36 against the rotary shaft 18. Due to the biasing force applied in a radially inward direction by the coil spring 38, this type of seal member 30 can provide a high sealing effect.

FIG. 4 shows an exemplary configuration of the present embodiment, in which the seal member 30 composed of a labyrinth seal 40 is used. The labyrinth seal 40 has a shape complementary to the stepped portion of the recess 24 formed on the front housing 14. Generally speaking, the seal member 30 composed of the labyrinth seal 40 can maintain a sealing effect, even when the electric motor 10 rotates at a high speed, and accordingly, is particularly advantageous for applications in which high-speed rotation of a motor is necessary.

FIG. 5 shows an exemplary configuration of the present embodiment, in which the seal member 30 comprised of a combination of a labyrinth seal and either a dust seal or an oil seal is used. As illustrated, the seal member 30 includes a first seal member 30′ comprised of an oil seal or a dust seal, and a labyrinth seal 40 provided on the outside of the first seal member 30′ in the axial direction of the electric motor 10. Such a combination of different types of seal members can improve the sealing effect. The combination of seal members is not limited to the illustrated example, and any combination can be adopted in accordance with the intended application.

According to the present embodiment, a seal member can be selected in accordance with the required rotation speed of an electric motor or the type of substances to be prevented from entering the inside of an electric motor. This allows a seal member suitable for the intended applications to be used, and accordingly a desired sealing action can be provided. The configuration and operational advantage of the present embodiment have been described with the exemplary seal member attached to one end of an electric motor. However, a person skilled in the art will appreciate that the concept of the present invention can also be applied to a seal member provided on the other end of the electric motor.

The inventor has also found that, in the case where the seal member 30 having no coil spring is used as shown in FIG. 2 and sized so as to have a predetermined range of dimensions relative to the rotary shaft 18, the lip portion 36 tends to wear out without breaking the seal member 30 as the rotary shaft 18 rotates, which causes the seal member 30 to fit with the rotary shaft 18. Namely, the lip portion 36 continues to wear out until the inner diameter of the lip portion 36 matches the outer diameter of the rotary shaft 18. This substantially eliminates a clearance between the seal member 30 and the rotary shaft 18.

For example, the seal member 30 is sized so that the interference of the lip portion 36 is between 0.1 mm and 0.3 mm. According to the present embodiment, providing an interference of at least 0.1 mm allows the entire periphery of the lip portion 36 of the seal member 30 to come in contact with the outer peripheral surface 18a of the rotary shaft 18. If the interference is, for example, less than 0.1 mm, a fastening force to press the seal member 30 against the rotary shaft 18 may be insufficient, and accordingly, a clearance may be locally formed between the seal member 30 and the rotary shaft 18.

On the other hand, limiting the interference to 0.3 mm or less allows the lip portion 36 to wear out appropriately on the rotary shaft 18 in rotation. In this technical field, the interference of a commonly used oil seal is generally set to approximately 0.8 mm, for example. When a seal member having such a relatively large interference is attached to a rotary shaft, a fastening force drastically increases, and accordingly, a lip portion rapidly wears out, thus resulting in breakage of the seal member. On the other hand, in the case of a seal member having a coil spring for applying a biasing force in a radially inward direction, since a fastening force becomes remarkably great, the seal member may be broken by friction.

According to the present embodiment, a seal member having no coil spring is adopted and designed to have an interference between 0.1 mm and 0.3 mm. This allows the seal member to wear out by friction by rotation of the rotary shaft 18 and as a result, the seal member fits with the rotary shaft. Thus, the seal member 30 can be attached to the rotary shaft 18 substantially without a clearance, and accordingly, the rotary shaft 18 can rotate at a high speed without breaking the seal member 30. Further, the amount of heat generated when the rotary shaft rotates at a high speed can be remarkably reduced.

It should be noted that the appropriate range of an interference of the seal member is not strictly limited between 0.1 mm and 0.3 mm. Rather, it may be necessary to adjust the interference slightly, depending on the material of the seal member 30 or the dimensions of the rotary shaft 18. However, even in such a case, a person skilled in the art will easily determine an appropriate range of the interference of a seal member in accordance with the intended use through experiments.

### EFFECT OF THE INVENTION

According to a producing method with the above features, an appropriate seal member is selected and used in accordance with the intended use. For example, a seal member can be selected in accordance with the required rotation speed or the type of foreign substances existing around an electric motor. Therefore, an electric motor compatible with a wide variety of applications, which vary depending on the type or intended use of an electric motor, can be provided.

Further, according to an electric motor with the above features and a method for producing the same, a seal member wears out by friction generated when a rotary shaft rotates and accordingly fits with the rotary shaft. Thus, the amount of heat can be reduced, and accordingly, an allowable speed of rotation can be increased.

Although various embodiments and variants of the present invention have been described above, it is apparent for a person skilled in the art that the intended functions and effects can also be realized by other embodiments and variants. In particular, it is possible to omit or replace a constituent element of the embodiments and variants, or additionally provide a known means, without departing from the scope of the present invention. Further, it is apparent for a person skilled in the art that the present invention can be implemented by any combination of features of the embodiments either explicitly or implicitly disclosed herein.

1. A method for producing an electric motor, the electric motor comprising:
a housing portion attached to at least one of end portions in an axial direction;
a rotor provided with a rotary shaft extending in the axial direction; and
an annular seal member provided between the housing portion and the rotor, the method comprising:
selecting, as the seal member, at least one of various types of seal members designed for different applications; and
customizing the selected seal member in accordance with the shape of the housing portion and the rotary shaft.

2. The method for producing the electric motor according to claim 1, comprising selecting, as the seal member, at least one of a seal member having a coil spring, a seal member having no coil spring, and a labyrinth seal.

3. The method for producing the electric motor according to claim 1, comprising selecting, as the seal member, a combination of a seal member having a coil spring and a labyrinth seal, or a combination of a seal member having no coil spring and a labyrinth seal.

4. An electric motor, comprising:
a housing portion attached to at least one of end portions in an axial direction;
a rotor provided with a rotary shaft extending in the axial direction; and
an annular seal member provided between the housing portion and the rotor,
wherein the seal member is configured to wear out by friction generated when the rotary shaft rotates, so as to fit with the rotary shaft.

5. The electric motor according to claim 4, wherein the seal member is a seal member having no coil spring.

6. A method for producing an electric motor, the electric motor comprising:
a housing portion attached to at least one of end portions in an axial direction;
a rotor provided with a rotary shaft extending in the axial direction; and
an annular seal member provided between the housing portion and the rotor,
the method comprising:
placing the seal member between the housing portion and the rotor so that an entire inner circumferential surface of the seal member is brought into contact with the rotary shaft; and
rotating the rotary shaft such that the seal member wears out so as to fit with the rotary shaft.

7. The method for producing the electric motor according to claim 6, comprising determining an inner diameter of the seal member and an outer diameter of the rotary shaft such that the seal member has an interference of between 0.1 mm and 0.3 mm, the seal member being a seal member having no coil spring.
